(19) United States
(12) Patent Application Publication
(10) Pub. No.: US 2015/0140917 A9
(43) Pub. Date: May 21, 2015

(54) SEALED DUCT CAB POST

(71) Applicants: PAUL Thomas BRUSS, Cedar Falls, IA (US); Terry S. Koch, Cedar Falls, IA (US); Robert L. Wood, JR., Independence, KS (US)

(72) Inventors: PAUL Thomas BRUSS, Cedar Falls, IA (US); Terry S. Koch, Cedar Falls, IA (US); Robert L. Wood, JR., Independence, KS (US)

(21) Appl. No.: 13/420,057

(22) Filed: Mar. 14, 2012

Related U.S. Application Data
(62) Division of application No. 12/248,524, filed on Oct. 9, 2008, now abandoned.

(51) Int. Cl. B60H 1/00; B60H 1/34

(52) U.S. Cl. CPC B60H 1/00271
USPC 454/143; 454/152

(57) ABSTRACT

The invention relates to a sealed duct vehicle cab post. A cab frame includes a hollow cab post having an air vent in a sidewall thereof and open first and second ends. A piece of unexpanded foam is attached to a clip. The clip has a base forming a foam piece support to which the piece of unexpanded foam is attached. The clip has a gripping member, and an arm connecting the base to the gripping member. The clip and the foam piece are inserted through the vent and into the post so that the unexpanded foam piece is inside the post and spaced apart from an edge of the vent and between the vent and the first end of the post. The gripping member is coupled to the post so that the gripping member grips, an edge of the vent. The cab frame and/or the post is then heated so that the foam expands and forms a seal within the post between the vent and the first end of the post. The result is a cab post with a sealed lower end wherein conditioned air from a roof mounted HVAC unit will flow from the upper end of the post, through the post to the vent and out of the vent and into the interior of the cab.

### FIELD OF THE INVENTION

The present invention relates to a sealed duct cab post.

This document (including all drawings) claims priority based on U.S. application Ser. No. 12/248,524, filed 9 Oct. 2008, and entitled, METHOD OF MAKING A SEALED DUCT FROM A CAB POST under 35 U.S.C. 119(e).

### BACKGROUND OF THE INVENTION

Utility vehicles such as tractors have cabs which include heating-ventilation-air conditioning (HVAC) units in the cab roof. It is well known that roof HVAC systems do not condition the air at the floor very well unless a duct is included that runs down to the floor. Such ducts can interfere with visibility from the inside of the cab.

Most utility vehicles have a roll-over protection system “ROPS” formed from hollow tubing. In some utility vehicles such hollow ROPS tubes have been used as air ducts, this has been done with very heavy tubes and welded plates on the bottom to force the air out of a hole where a vent louver is placed. This has the disadvantage of high cost and problems with holding paint when using an e-coat system.

### SUMMARY OF THE INVENTION

Accordingly, an object of this invention is to provide a sealed duct cab post.

This and other objects are achieved by the present invention, wherein a hollow cab post has open ends and a vent opening in a side surface. A piece of unexpanded foam is assembled to a clip. The clip is inserted through the vent opening so that the unexpanded foam is held inside the post to one side of the vent opening. The cab frame, including the post assembly, may be dunked in an e-coat tank, after which the paint drains out of the post and around the unexpanded foam. This assembly is then heated, such as in a e-coat oven. The foam expands until it sealingly engages the inner walls of the post. This seals one end of the post and forces conditioned air to flow out of'the post, through the vent opening and into the interior of the cab.

### BRIEF DESCRIPTION OF THE DRAWINGS

FIG. 1 is a perspective view of a vehicle post assembly;

FIG. 2 is a perspective view of a clip member of the present invention;

FIG. 3 is a perspective view of a seal assembly of the present invention;

FIG. 4 is an enlarged perspective view of the seal assembly mounted in a cab post;

FIG. 5 is an exterior perspective view of the seal assembly mounted in a cab post; and

FIG. 6 is an enlarged perspective view of the seal assembly mounted in a cab post with the foam piece expanded.

### DESCRIPTION OF THE PREFERRED EMBODIMENT

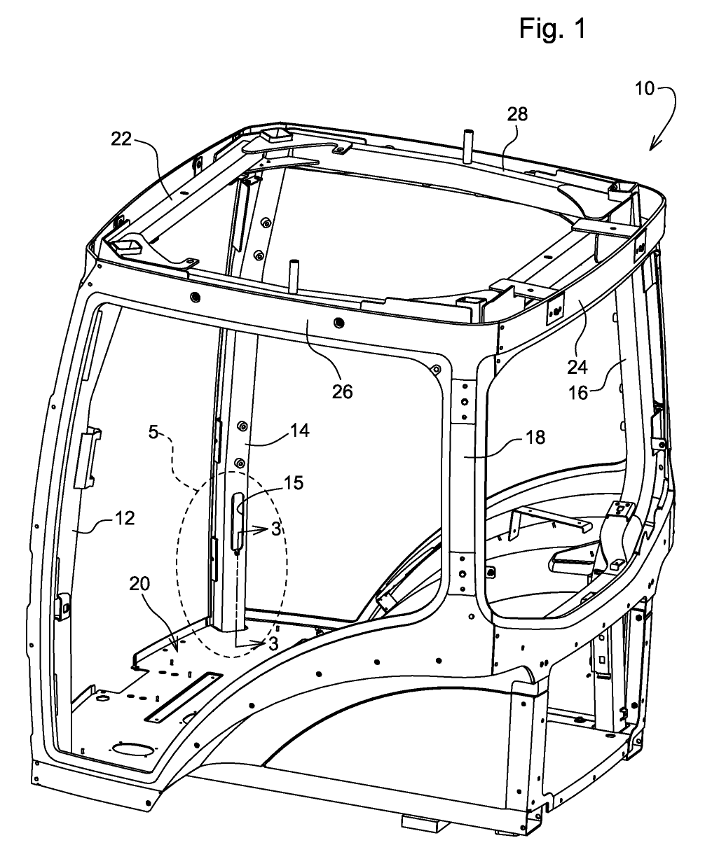

Referring to FIG. 1, a vehicle cab frame 10 includes corner posts 12, 14, 16 and 18 fixed, such as by welding, to a base 20 and to an upper front member 22 an upper rear member 24 an upper left side member 26 and an upper right side member 28. These members are hollow and are preferably strong enough to function as roll-over-protection or “ROPs”. The posts, such as post 14, includes an aperture or air vent 50 in an inwardly facing side wall thereof. Initially, both the upper and lower ends of the posts 14 are open. The upper end will remain open so it can receive conditioned air from a roof mounted HVAC system (not shown).

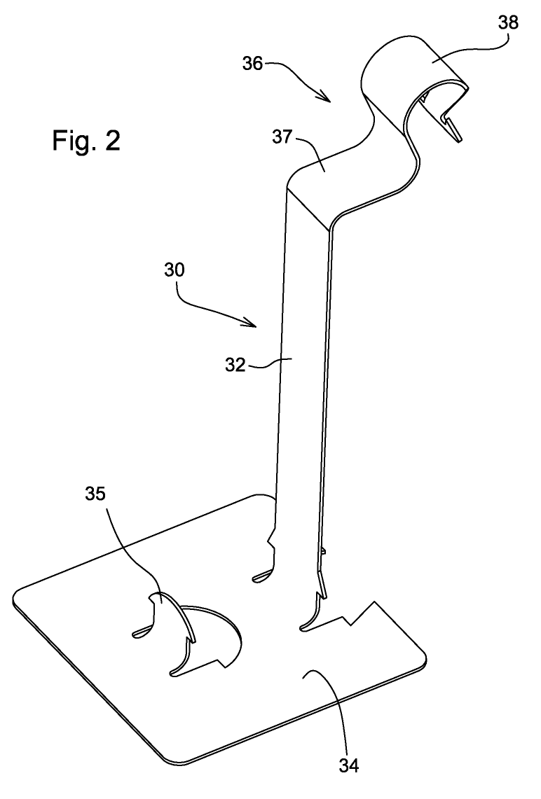

Referring now to FIG. 2, a clip member 30 includes an arm 32 which extends between a flat horizontal rectangular base 34 and an upper part 36. A tab 35 projects upwardly from the base 34. Upper part 36 includes a horizontal arm 37 and a gripping part 38 which is bent to form a downwardly opening slot.

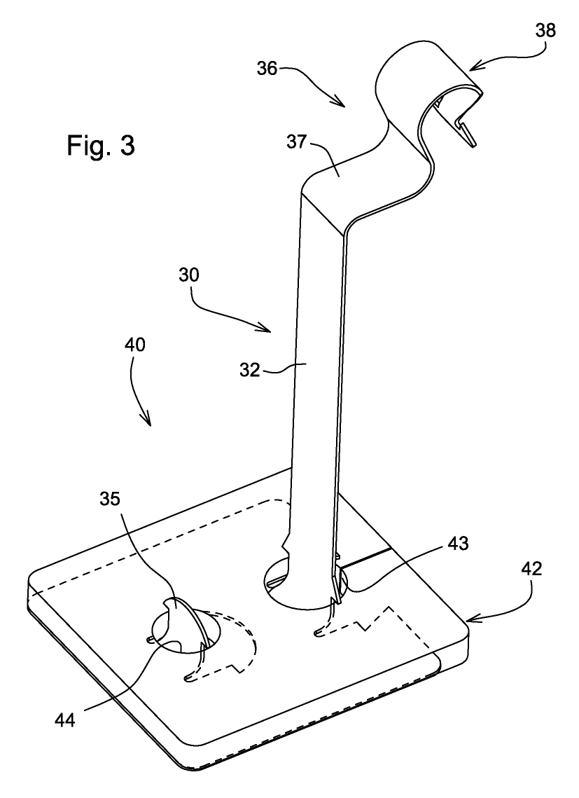

Referring now to FIG. 3, a seal insert assembly 40 includes the clip member 30 and a rectangular piece 42 of unexpanded foam mounted on the base 34. Preferably, the foam is conventional foam such as has been used for many years in the auto industry to prevent road noise from getting into passenger compartments. Foam piece 42 includes a pair of apertures 43 and 44. Aperture 43 receives a lower part of arm 32. Tab 35 projects through aperture 44.

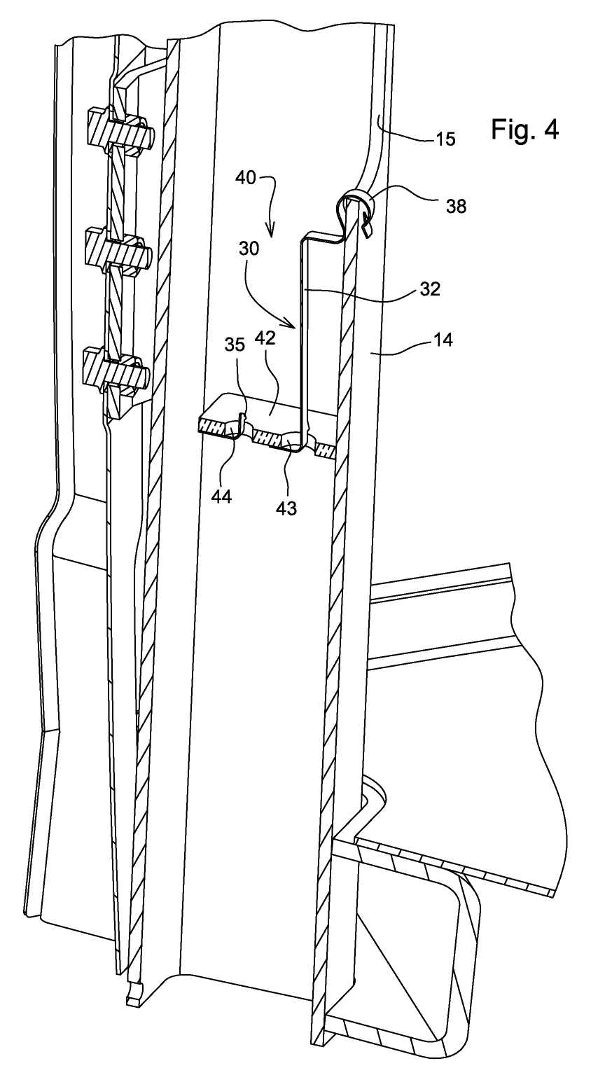

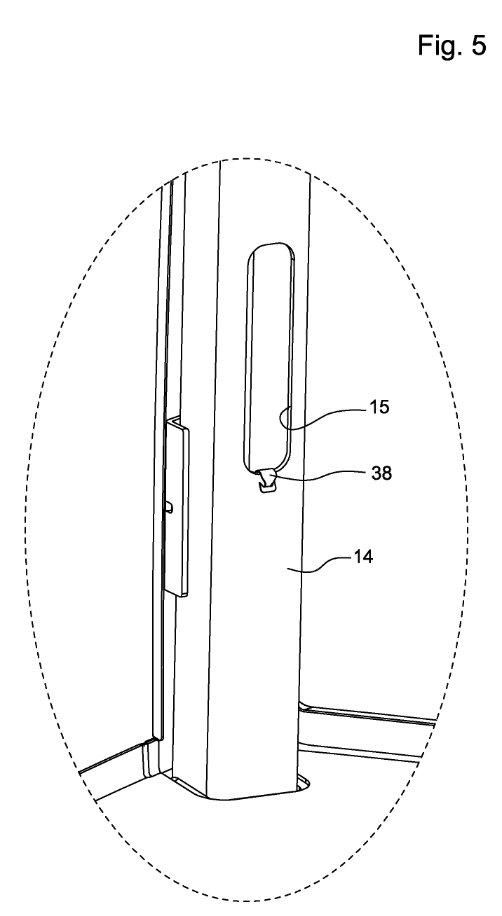

As best seen in FIGS. 4 and 5, the seal insert assembly 40 is inserted through vent 15 and into the interior of the post 14 so that the unexpanded foam 42 is held inside the post 14 spaced apart and below or to one side of the vent 15, and so that the gripping part 38 grips and hangs on a lower edge of the vent 15.

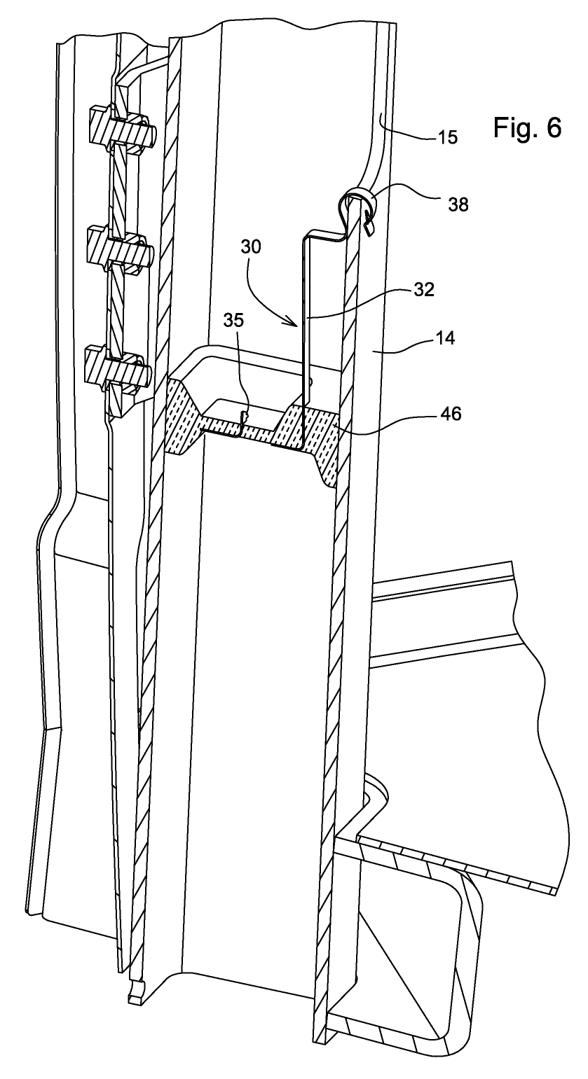

The entire cab frame 10, including the post assembly as shown in FIGS. 4 and 5, may then be dunked in a paint or e-coat tank (not shown), after which paint drains out of the post 14 and around the unexpanded foam piece 42. The entire cab frame 10 is then heated, such as in a paint or e-coat oven (not shown). The foam piece 42 expands until the expanded foam 46 sealingly engages the inner walls of the post 14, as best seen in FIG. 6. This seals the lower end of the post 14 and forces conditioned air to flow out of the post 14, through the vent opening 15 and into the interior of the cab.

This design is reasonably simple. Yet, it eliminates the need for welding, avoids paint problems, and avoids the difficulty of trying to install already expanded foam into a tube in a manner which guarantees it won't fall out, completely plugs the tube.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. A post for a vehicle cab frame, the post comprising:
a hollow post having a first end, a second end and an air vent in a sidewall thereof, the first end being open and adapted to receive conditioned air from an HVAC system; and
a seal formed within the hollow post between the air vent and the second end of the hollow post.

2. The post of claim 1, wherein:
the hollow post is strong enough to function as roll-over-protection.

3. The post of claim 1, wherein:
the air vent faces inwardly.

4. The post of claim 1, wherein:
the hollow post forms a duct for communicating conditioned air from the first end through a portion of the hollow post to the vent and out of the vent.

5. A cab frame comprising:
an upper member;
a base member; and
at least one hollow post which is fixed to the upper member and the base member, the hollow post having a first end, a second end and an air vent in a sidewall thereof, the first end being open and adapted to receive conditioned air from an HVAC system, and a seal formed within the post between the air vent and the second end of the post, the hollow post forming a duct for communicating conditioned air from the first end through a portion of the post to the vent and out of the vent.

6. The cab frame of claim 5, wherein:
the hollow post is a corner post.
